(19) United States
(12) Patent Application Publication
(10) Pub. No.: US 2017/0219724 A1
(43) Pub. Date: Aug. 3, 2017

(54) NEUTRON DETECTION

(71) Applicant: KROMEK LIMITED, Sedgefield (GB)

(72) Inventor: Edward MARSDEN, Sedgefield (GB)

(73) Assignee: KROMEK LIMITED

(21) Appl. No.: 15/129,226

(22) PCT Filed: Mar. 27, 2015
(86) PCT No.: PCT/GB2015/050921

§ 371 Date: Sep. 26, 2016

(30) Foreign Application Priority Data
Mar. 27, 2014 (GB) 1405556.0

(51) Int. Cl. G01T 3/06

(52) U.S. Cl. CPC G01T 3/06

(57) ABSTRACT

A neutron detection system is described comprising a neutron scintillator detector having a detection area, wherein the detection area is segmented into a plurality of discrete sub-regions, and a light readout system is provided with a corresponding plurality of discrete channels each to detect a respective output of a respective discrete sub-region.

The invention relates to neutron detection. The invention specifically relates to a neutron detection system and to a method of neutron detection using such a detection system. The invention in particular relates to the development and use of high performance low cost large area neutron scintillator detectors.

For the passive detection of nuclear threat materials, in security applications, high sensitivity and large sensitive area neutron detectors are essential in order to identify relatively small amounts of material, within shielding. Traditionally, the high cost of detector materials has led to compromise over the amount of sensitive material which can realistically be employed in such systems. In order to meet the ever increasing demands for more effective search and screening devices, it is not only advantages, but essential that these detection systems improve by an order of magnitude in sensitivity. With increasing cost constraints this can only be done by dramatically reducing the inherent cost to sensitivity ratio of the detector active components. High sensitivity, large area neutron detectors are an essential part of these systems.

Bulk neutron scintillation detectors are commonly prone to false neutron triggering, in high gamma fields. One of the key performance parameters for neutron scintillators is effectiveness of rejection of interference by gamma radiation. In many applications, such as homeland security and nuclear safeguarding, detectors are required that produce less than one false neutron identification in every 10⁶ gammas impinging on the detector. In this case the gamma sensitivity, also known as gamma rejection rate is 10⁻⁶.

Enhanced gamma rejection is often achieved by means of signal processing techniques, known as pulse shape discrimination, whereby different temporal characteristics of signals generated on neutron and gamma interaction is exploited. However in high gamma fields these techniques are often insufficient to achieve desired gamma rejection rates, due to pulse pile up in the signal chain. Pulse pile up occurring at higher gamma rates will always have the potential to generate signals which are very difficult to discriminate from neutrons.

In accordance with the invention in a first aspect, a neutron detection system comprises a neutron scintillator detector having a detection area, wherein the detection area is segmented into a plurality of discrete sub-regions, and a light readout system is provided with a corresponding plurality of discrete channels each to detect a respective output of a respective discrete sub-region.

The invention is thus characterised in that the detection area of the detector is segmented into a plurality of discrete sub-regions and the scintillator output of each such sub-region is separately addressable to produce a separately processable light readout.

Segmenting the detection area of the detector, and performing light readout in a number of discrete channels (as opposed to a single grouped output achieved by a traditional photomultiplier) effectively reduces the gamma rate impinging on any one part of the detector. The number of gamma interactions in each channel will be significantly reduced, resulting in less scope for gamma signal pulse pile up, and this enables sufficient time for gamma rejection through pulse shape discrimination, thus enhancing gamma rejection rates and consequently reduction in false neutron triggering.

The neutron scintillator detector typically comprises as will be familiar a neutron responsive scintillator comprising a combination of a neutron capture isotope such as ⁶Li or ¹⁰B, either enriched or in natural abundance with a scintillating compound, and provided in association with a suitable photodetector to detect light emitted by the scintillating compound. The invention is applicable to such known scintillator detectors.

The photodetector comprises a photoelectric transducer coupled to the scintillator material to generate an electrical signal in response to its luminescence and is for example a photomultiplier. Photodetectors can include photomultipliers, photodiodes, and silicon photomultipliers. In the preferred case the photoelectric transducer is a solid state transducer, for example comprising a silicon photomultiplier.

Segmentation can be achieved for example by dividing a bulk scintillator detector into a plurality of discrete separately addressable elements and using a corresponding plurality of photodetectors, or by provision of wavelength shifting light guides or fibres to couple light from a plurality of areas on a distributed detector to a corresponding array of photodetectors.

The scintillator can be coupled directly to a photodetector, but in a preferred case to achieve sensitivity over a relatively large area the light generated in the scintillator can be coupled to a photodetector by means of light guides and for example wavelength shifting light guides. Plural such wavelength shifting light guides provide an effective means by which the detection area of the detector may be segmented into a plurality of discrete sub-regions and the scintillator output of each such sub-region may be made separately addressable.

In a preferred embodiment the scintillator detector of the invention comprises a large area neutron responsive scintillator, a plurality of separately addressable photodetectors, and a corresponding plurality of light guides, for example wavelength shifting light guides, for example wavelength shifting fibres, disposed to couple light from each of a plurality of areas on the scintillator to a corresponding one of the separately addressable photodetectors. The light guides are for example fluoresecent light guides and for example fluoresecent fibres. Suitable fibre light guides are for example polymeric fibres comprising a high refractive index core with low refractive index cladding. The fibres are for example fabricated from polystyrene and/or polymethylmethacrylate.

In a particularly preferred embodiment, each light guide and for example each wavelength shifting fibre is additionally provided with a coating of a neutron capture/scintillating mixture, which may be of the same or a different composition to the neutron capture/scintillating mixture of the neutron responsive scintillator, to achieve a high sensitivity highly segmented system. The coating for example comprises one or more neutron capture materials selected from boron nitride, lithium fluoride, mixed or chemically combined with one or more scintillating compounds selected from zinc sulphide, zinc oxide.

In this embodiment light generated in the scintillator is directly coupled to an inherently fluorescent light guide, inducing luminescence in the light guide. The coated light guide transmits the generated light by total internal reflection to the photodetector.

Coated fibres embodying this feature can be up to several meters long, and can be combined in large numbers to achieve sensitivity over a wide area, while maintaining very high gamma rejection.

Each photodetector in the plurality of separately addressable photodetectors may comprise a discrete photodetector element but may alternatively comprise an area of a larger photodetector that is otherwise configured for a separate and discrete light read out, for example via suitable control electronics.

The invention offers the potential to realize a large area, wide energy, neutron detector with at least an order of magnitude improvement in cost and performance over existing technology such as ³He, ⁶Li based systems. These performance and cost benefits will potentially help realize a new generation of fixed and transportable passive detection systems. The proposed technique also offers potential benefits in background suppression, directionality/imaging.

A further benefit of segmented light readout in scintillation detectors based on solid-state photo-detectors is potential reduction improvement in signal to noise ration and a resultant benefit in energy range and energy resolution.

The detection area of the detector is preferably segmented into a plurality of discrete sub-regions in a two-dimensional area array. For example in the preferred embodiment the detector comprises a large area neutron responsive scintillator, a plurality of separately addressable photodetectors, and a corresponding plurality of light guides disposed to couple light from each of a plurality of areas on the scintillator defining a two-dimensional area array to a corresponding one of the separately addressable photodetectors.

The invention may be applied to all thermal and fast neutron scintillation detectors.

Technologies include composite scintillators (e.g. ⁶LiF:ZnS, ¹⁰BN:ZnS), inorganic scintillators (⁶LiI, Cs2LiYCl6:Ce), organic neutron scintillators (e.g. BC-454). The scintillation detector of the invention may in a preferred case comprise a thin composite scintillator distributed in a moderator.

An example composite scintillation detector discussed in more detail below comprises boron nitride and for example comprises non-enriched boron nitride platelets evenly distributed in a moderator.

The invention is applicable to large sensitive area neutron detectors and for example comprises detectors of area at least 50 cm², preferably at least 500 cm², for example up to 5000 cm² or larger.

In accordance with the invention a segmented light readout system is provided with a plurality of discrete channels each to detect a respective light output of a respective discrete sub-region so that the output of each segmented sub-region can be separately processed. A segmented light readout system in accordance with the invention may for example comprise a distributed light collection network which may for example make use of discrete solid state sensors and dynamic signal processing techniques.

A segmented light readout system for example comprises a solid-state, distributed light guide readout. A segmented light readout system for example comprises fluorescent light guides. A segmented light readout system for example comprises solid-state photodetectors.

In accordance with the invention in a further aspect a method of neutron detection comprises:

providing a neutron scintillator detector having a detection area in the vicinity of an object/source to be tested;

segmenting the detection area into a plurality of discrete sub-regions;

obtaining a light readout output of each respective discrete sub-region.

The method is thus characterised in that the detection area of the detector is notionally segmented into a plurality of discrete sub-regions and the scintillator output of each such sub-region is separately addressable to produce plural separately processable segmented light readouts, producing the advantages set out above in relation to reduction of gamma interactions resulting in less scope for gamma signal pile up, and consequently reduction in false neutron triggering.

In particular therefore the method is a method of neutron detection using a detection system in a first aspect of the invention and preferred features of the method will be understood by analogy.

Particularly preferred examples of boron nitride composite scintillation detectors are discussed by way of example below with reference to the figures in which:

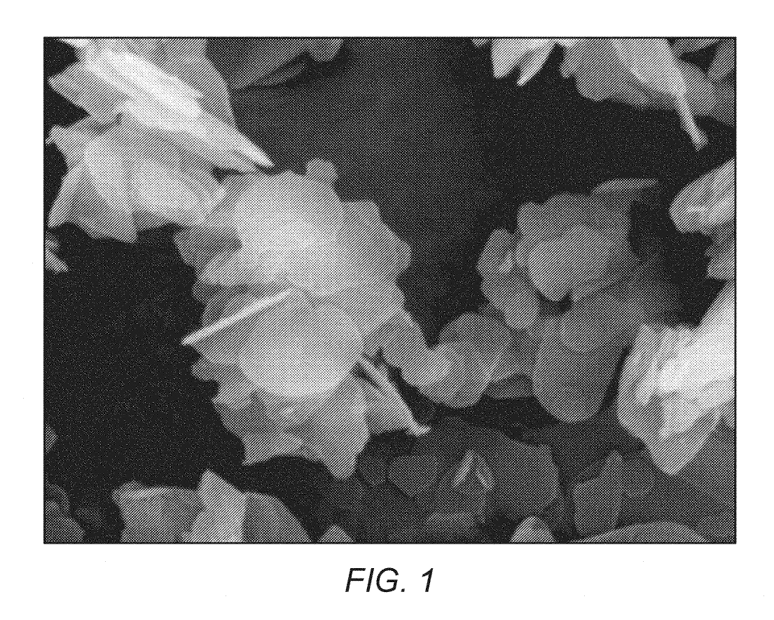

FIG. 1 is a micrograph of an example ¹⁰BN scintillator material;

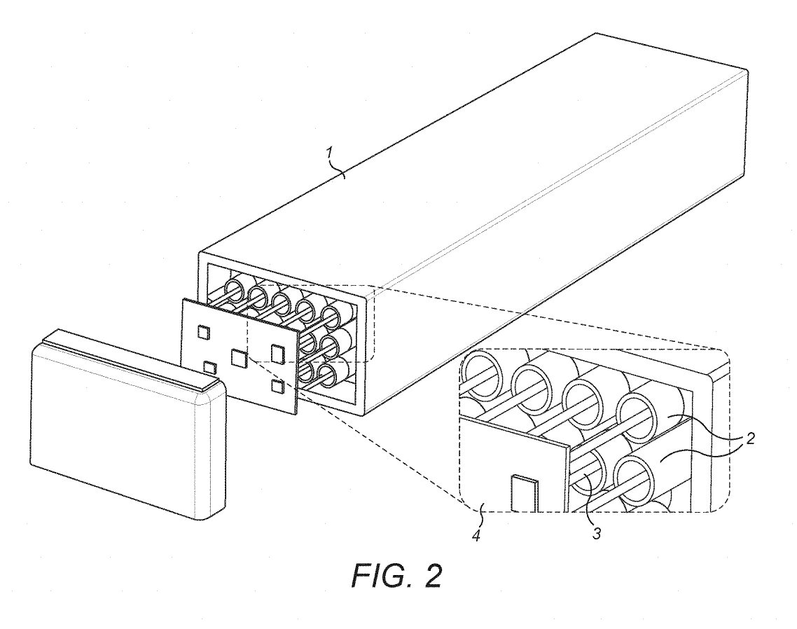

FIG. 2 is an example solid state distributed light guide readout for use in an embodiment of the device of the invention;

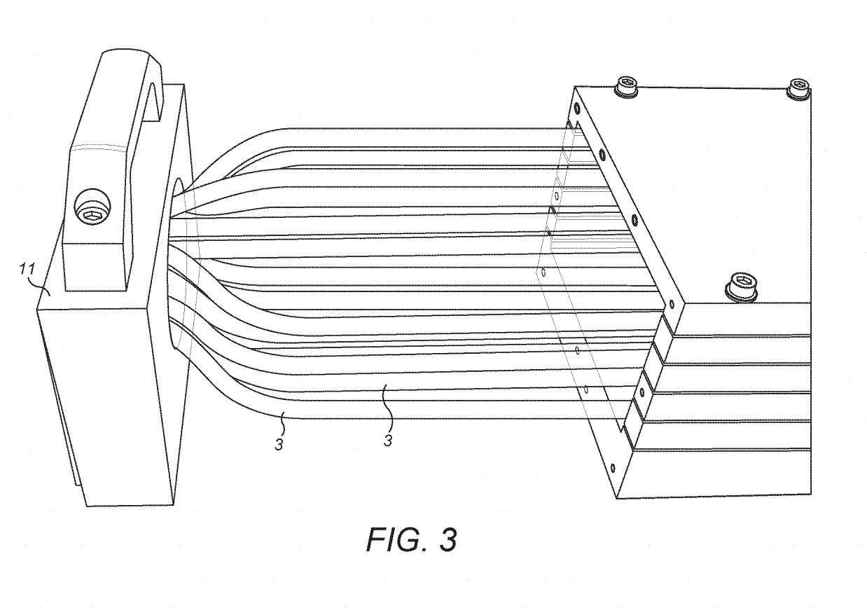

FIG. 3 is a scintillator and fibre system for use in conjunction with the light guide readout of FIG. 2 in an embodiment of the device of the invention.

The objective of the invention is to realize a large area, wide energy, neutron detector with at least an order of magnitude improvement in cost and performance over existing technology such as ³He, ⁶Li based systems. Target specification for the detector is 50% efficiency (²⁵²Cf neutrons), 1 m² sensitive area, 10⁻⁷ gamma rejection, with a target cost (in quantity) of $10 k/ m². These performance and cost points will potentially help realize a new generation of fixed and transportable passive detection systems.

A critical challenge that the invention seeks to meet is to achieve high sensitivity, low noise, stable sensor operation at room temperatures (>70° F.) for a large sensitive area device, and to scale this to achieve the target specification. In this regard a composite scintillation detector comprising non-enriched boron nitride platelets evenly distributed in a moderator is given by way of example below.

Neutron scintillator detectors typically comprise a neutron capture isotope such as ⁶Li or ¹⁰B, either enriched or in natural abundance. Compounds containing these isotopes, such as BO, BN, LiF are either mixed or chemically combined with an inorganic scintillating compound such as ZnS:Ag, ZnO, LiI:Eu, or complex organic compounds, whereby the high energy reaction products from neutron interactions with the capture compound produce scintillation in the scintillator.

In the example embodiment of the invention, a suitable neutron responsive scintillator makes use of non-isotopically enriched boron nitride.

Non-isotopically enriched boron is readily available as a fine (sub-micron) powder, as a low cost cosmetics ingredient. Its hexagonal platelet structure offers excellent properties as a neutron capture agent in composite scintillating panels (see FIG. 1); whereby this self lubricating fine powder enables effective coupling of the charged neutron reaction products to the scintillating matrix. The resulting thin, high sensitivity material can be evenly distributed in a moderator, for very high efficiency across wide energy range, and low gamma sensitivity; suitable for portable/transportable and scalable to very large detectors.

Wavelength shifting light guides allow the scintillator to be distributed over a large sensitive area. Segmented solid-state light readout will provide robust gamma rejection (in high gamma fields where pulse pile up can occur in a bulk detector). Integrated signal processing will complete a self contained robust and scalable detection system. An example light guide is shown in FIG. 2. In this figure a housing 1 contains a two dimensional array of guide tubes 2 through each of which a fluorescent fibre 3 couples to a separately addressed photodetector component of a silicon photomultiplier photodetector 4.

Additionally segmented and bi-directional readout of individual light guides provides great potential for directionality and energy discrimination in the device. A possible device configuration is shown in FIG. 3.

In FIG. 3 a large area neutron responsive scintillator 11 is coupled to the photodetector via a two dimensional array of fluorescent fibres. Each fibre couples a discrete area of the scintillator to a separately addressed photodetector element to obtain a discrete photoresponse attributable to that area of the scintillator only. Segmentation of the scintillator, readout devices and signal processing of the scintillator effectively reduces the gamma rate impinging on any one part of the detector. This significantly reduces pulse pile up and enables sufficient time for gamma rejection through pulse shape discrimination, thus enhancing gamma rejection rates.

In the example embodiment of the invention, the fibres are fabricated from a suitable fluorescent material and for example fluorescent polymeric material. The fluorescent fibres are for example polymeric fibres comprising a high refractive index core with low refractive index cladding and are for example fabricated from polystyrene and/or polymethylmethacrylate. The fibres are additionally provided with a coating of a coating of a neutron capture material and scintillating material mixture. The coating for example comprises one or more neutron capture materials selected from boron nitride, lithium fluoride, mixed or chemically combined with one or more scintillating compounds selected from zinc sulphide, zinc oxide.

Light generated in the scintillator is directly coupled to the fluorescent fibre, inducing luminescence in the fibre. The plural clad fibres transmit the generated light from each respective area of the scintillator by total internal reflection to the respective photodetector elements for separate processing to achieve sensitivity over a wide area scintillator, while maintaining very high gamma rejection.

Significant design considerations in developing a device for particular applications include:
To meet the specification requirement a new level of sensitivity and gamma rejection is required, demanding improvements in detector efficiency and signal to noise.
Improved coating formulas and application techniques are required, to enhance sensitivity, maintain good light output and enhance stability/robustness.
Efficiently coupling light from the scintillating layer to the photo-detector is key to the successful implementation of the technique. This requires highly efficient light guides, matching the characteristics of the scintillator and photo sensor.
Solid state photo-detectors close to the performance of photomultipliers are at the technical limit of commercially available sensors. Signal processing and stabilization techniques are required.
The new detector platform must be optimized for performance, against size and weight. This requires extensive modeling of neutron interactions and a clear focus on requirement specifications.

1-22. (canceled)

23. A neutron detection system comprising a neutron scintillator detector having a detection area, wherein the detection area is segmented into a plurality of discrete sub-regions, and a light readout system is provided with a corresponding plurality of discrete channels each to detect a respective output of a respective discrete sub-region, wherein the neutron scintillator detector comprises a neutron responsive scintillator comprising a combination of a neutron capture isotope with a scintillating compound, and provided in association with a photodetector to detect light emitted by the scintillating compound; and wherein the light readout system is a segmented light readout system having a plurality of discrete channels each to detect a respective light output of a respective discrete sub-region so that the output of each segmented sub-region can be separately processed.

24. The detection system in accordance with claim 23 wherein the segmented light readout system comprises a solid-state, distributed light guide readout.

25. The detection system in accordance with claim 23 wherein the segmented light readout system comprises a plurality of fluorescent light guides.

26. The detection system in accordance with claim 23 wherein the scintillator detector comprises a neutron responsive scintillator, a plurality of separately addressable photodetectors, and a corresponding plurality of light guides each disposed to couple light from one of a plurality of areas on the scintillator to a corresponding one of the separately addressable photodetectors.

27. The detection system in accordance with claim 26 wherein each light guide is a wavelength shifting light guide.

28. The detection system in accordance with claim 27 wherein each wavelength shifting light guide is a wavelength shifting fibre.

29. The detection system in accordance with claim 28 wherein each fibre is fabricated from one or more materials comprising a high refractive index core with low refractive index cladding.

30. The detection system in accordance with claim 26 wherein each light guide is provided with a coating of a neutron capture material and scintillating material mixture.

31. The detection system in accordance with claim 30 wherein the coating comprises one or more neutron capture materials selected from LiF, BN mixed or chemically combined with one or more inorganic scintillating compounds selected from ZnS(Ag), ZnO, YAlO3:Ce.

32. The detection system in accordance with claim 23 wherein the photodetector comprises a silicon photomultiplier.

33. The detection system in accordance with claim 23 wherein the photodetector is divided into a plurality of separately addressable regions.

34. The detection system in accordance with claim 33 wherein the each separately addressable region of the photodetector is configured for a separate and discrete light read out via suitable control electronics.

35. The detection system in accordance with claim 23 wherein the detection area of the detector is segmented into a plurality of discrete sub-regions in a two-dimensional area array.

36. The detection system in accordance with claim 35 wherein the detector comprises a large area neutron responsive scintillator, a plurality of separately addressable photodetectors, and a corresponding plurality of light guides disposed to couple light from each of a plurality of areas on the scintillator defining a two-dimensional area array to a corresponding one of the separately addressable photodetectors.

37. The detection system in accordance with claim 23 wherein the neutron scintillator detector comprises a composite scintillator distributed in a moderator.

38. The detection system in accordance with claim 23 wherein the detector has a detection area of at least 500 cm2.

39. The detection system in accordance with claim 23 wherein the detector has a detection area of at least 5000 cm2.

40. A method of neutron detection comprising the steps of:
providing a neutron scintillator detector having a detection area in the vicinity of an object/source to be tested;
segmenting the detection area into a plurality of discrete sub-regions;
obtaining a light readout output of each respective discrete sub-region;
wherein the step of segmenting the detection area into a plurality of discrete sub-regions is carried out by provision of a neutron responsive scintillator, a plurality of separately addressable photodetectors, and a corresponding plurality of light guides each disposed to couple light from one of a plurality of areas on the scintillator to a corresponding one of the separately addressable photodetectors; and by provision of a segmented light readout system having a plurality of discrete channels each to detect a respective light output of a respective discrete sub-region so that the output of each segmented sub-region can be separately processed.
